(19) United States
(12) Patent Application Publication
(10) Pub. No.: US 2007/0029394 A1
(43) Pub. Date: Feb. 8, 2007

(54) Covert document system

(76) Inventors: David M. Wicker, Dansville, NY (US); Michael Scott Caton, Oakfield, NY (US)

Correspondence Address: MCDERMOTT WILL & EMERY LLP, 600 13TH STREET, N.W., WASHINGTON, DC, 20005-3096, US

(21) Appl. No.: 11/495,900

(22) Filed: Jul. 31, 2006

Related U.S. Application Data
(60) Provisional application No. 60/703,860, filed on Aug. 1, 2005.
(60) Provisional application No. 60/794,826, filed on Apr. 26, 2006.

(51) Int. Cl. G06K 19/06

(52) U.S. Cl. 235/494

(57) ABSTRACT

This invention relates generally to document protection methods and product. More specifically, the present invention relates to a method for hiding information in a document by means of a latent image or message, which is practically invisible to the naked eye and may only be revealed through use of a matching viewing device. The present invention further relates to a method for creating original documents containing latent messages, which are revealed when the document is read by a viewing device. In one embodiment, print elements such as lines, dots, spots, swirls, or images are used to form covert information. The covert information print elements are disposed at an angle to print elements of a background, thus creating a covert document. In another embodiment, print elements of the covert information are used with a solid background.

### RELATED APPLICATION

Priority for the present application is based on U.S. Provisional Patent Application 60/703,860, filed Aug. 1, 2005, and 60/794,826, filed Apr. 26, 2006.

### FIELD OF THE INVENTION

This invention relates generally to document protection methods and product. More specifically, the present invention relates to a method for hiding information in a document, by means of a latent image or message, which is practically invisible to the naked eye and may only be revealed through use of a matching viewing device. The present invention further relates to a method for creating original documents containing latent messages, which are revealed when the document is read by a dedicated viewing device.

### BACKGROUND OF THE INVENTION

Secure documents have been produced in the past by letterpress, offset or intaglio printing processes. At present there exists a need for secure documents to be printed not only over the internet and output on a printer, but also the ability to remotely print tickets and coupons that contain common security features and individualized “hidden” information.

Additionally, the need exists for secure images for solid color printed areas. In the past, most security tints were comprised of dot and line screens, usually not over 50% in density, but as a need for packaging security is on the increase, there exists a need to add security features to printing designs. More specifically in pharmaceutical and automotive packaging, most artwork designs contain an increasing number of solid color areas that traditionally have not contained any printed security.

### SUMMARY OF THE INVENTION

It is an object of the present invention to provide enhanced security for covert documents that are to be embedded with variable and/or static covert information. It is understood for all of the following embodiments that a document can take many forms, including an electronic document as well as a hard copy.

There is thus provided in accordance with one embodiment of the present invention, an advanced method of concealing covert information in a document that is transmitted (for example, over the internet, extranet, wireless, facsimile, etc.), copied, or otherwise successfully reproduced on an output device such as a printer. Covert information is hidden by creating a first and a second print structure and then combining them.

There is also provided in accordance with another embodiment of the present invention, a tint for concealing the covert information from unintended users. The covert information is hidden from view by means of an apparently solid tint, which does not reveal information when viewed with the naked eye, photocopied, scanned or digitally photographed. Any attempt to reproduce or copy the document in any way may result in an unreadable tinted area. Alternatively, the document may be copied in substantially identical form including the covert information, which remains masked from the naked eye, but is still viewable by a dedicated viewing device, even after transmission, copying, or other reproduction.

Further, in accordance with an embodiment of the present invention, the step of masking the covert information may be achieved using any color, ink, toner or inkjet fluid. The step of masking the covert information is most effectively achieved using a dark tint, or metallic or UV/IR inks. The step may be further effectively achieved by printing specific frequencies over a foil image.

Additionally, in accordance with an embodiment of the present invention, the step of masking the covert information is achieved utilizing lines, dots, spots, swirls, or images, generally referred to as print elements, either individually or in combination. The step of masking the covert information is most effectively achieved using print elements of equal size and density.

Still further in accordance with an embodiment of the present invention, the print elements of the covert information should be placed at substantially orthogonal angles to each other in order to most effectively conceal information. The most effective positioning of the screens would be 135°/45°, with one angle for the covert information and one angle for background.

Further, in accordance with an embodiment of the present invention, the step of establishing the angles of the print elements is dependent on defining the print element screens. The print element may be imaged between 60 and 500 lines per inch, and may be most effective at 150 lines per inch for covert information and the surrounding areas. Screen frequency units most commonly used are lines per inch (“lpi”), but it is understood that print elements other than lines could be utilized; “lpi” is still used as a frequency unit as a matter of convenience. Additionally, the density of the covert information print element tint may be between 10% and 50%, preferably at or about 20%.

Additionally, for the embodiment of the present invention that is incapable of being transmitted, copied, or reproduced, several print element screens are the most effective at not being reproduced, namely 60-300 lpi, and most preferably 120-190 lpi.

In accordance with an embodiment of the present invention, there is provided a dedicated viewing device, which is specifically suited to the document, substantially matching the frequency of the covert information print elements. When held in a substantially flat position against the covert information on the document, the dedicated viewing device reveals it while making the background appear less noticeable.

Further, in accordance with an embodiment of the present invention, the dedicated viewing device may be a lens made of either plastic, glass or film substrate. Dedicated viewing devices may be designed to be easily destroyed after use to ensure extra document security. The dedicated viewing device may be clear, tinted or lined to assist the viewing of the covert information and may contain several distinct areas for viewing of multiple screened areas.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The present invention will be more fully understood an appreciated from the following detailed description, taken in conjunction with the drawings, in which:

FIG. 1 is an illustration of one embodiment of the present invention where covert information is being revealed through a dedicated viewing device.

FIG. 2 is a simplified illustration of solid lines of the covert information disposed at a different angle to the solid lines of the background.

FIG. 3 is a simplified illustration of the solid lines of the covert information containing a print code.

FIG. 4 is a simplified illustration of another embodiment of the present invention using a solid tint background with print elements of the covert information.

### DETAILED DESCRIPTION OF THE PREFERRED EMBODIMENTS

The present invention provides a method of masking information from unintended users and enabling observation of information through a dedicated viewing device.

In a typical scenario, in accordance with the present invention, a user wanting to convey covert information contained within a document to a specific recipient may provide the recipient with a matching viewing device designed to match the document and recognize the covert information. The covert information may be concealed from view and may not be accessed unless a suitable viewing device is used. Any other recipient of the same document would not have access to the covert information concealed from view and would be unaware of the covert information present within the document or would only be privy to specific information located on a specific area of the document.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways, such as laminates or holographic foils. Also, it is to be understood that the phraseology and terminology employed herein is for the purpose of description and should not be regarded as limiting.

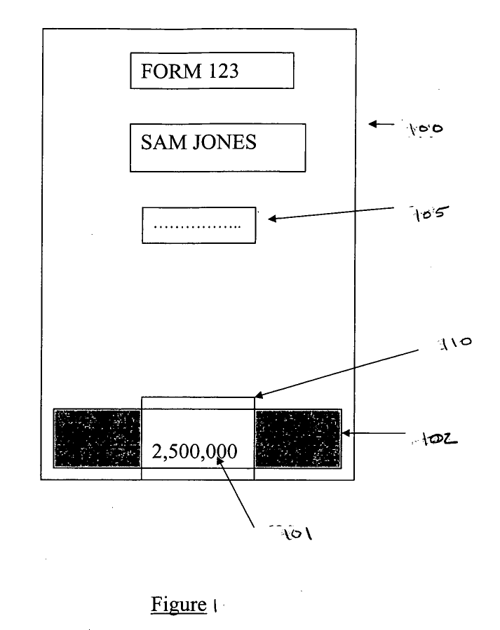

Referring now to FIG. 1, a covert document form 100 contains covert information 101, background 102, and fillable field 105. Also shown is dedicated viewing device 110.

In one embodiment of the present invention, the user inserts covert information 101 into background 102, as described in detail below. Covert document 100 is then ready to be transmitted, copied, or otherwise successfully reproduced by an output device (not shown). The output device may be a copier, scanner, fax machine, or the like.

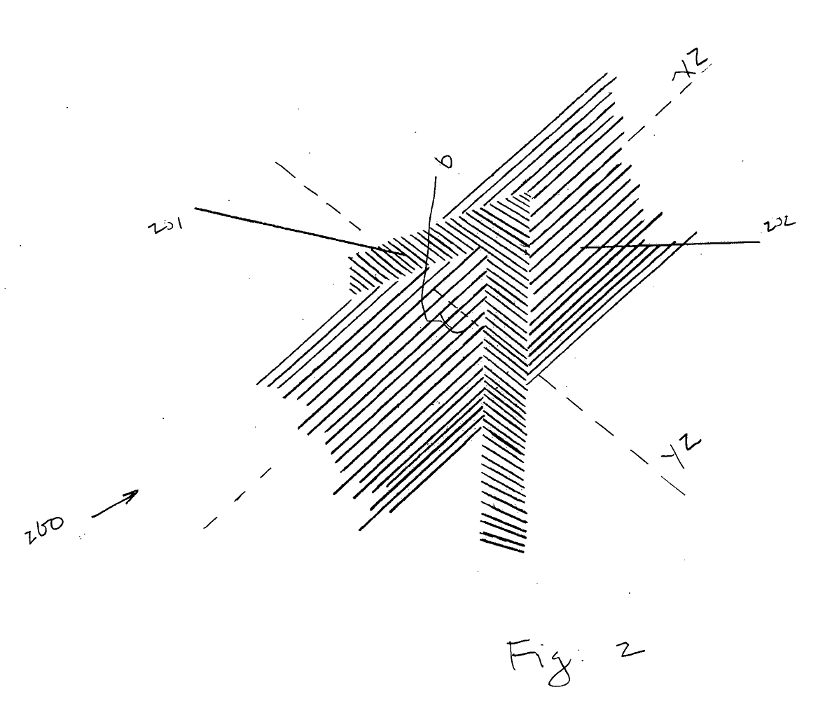

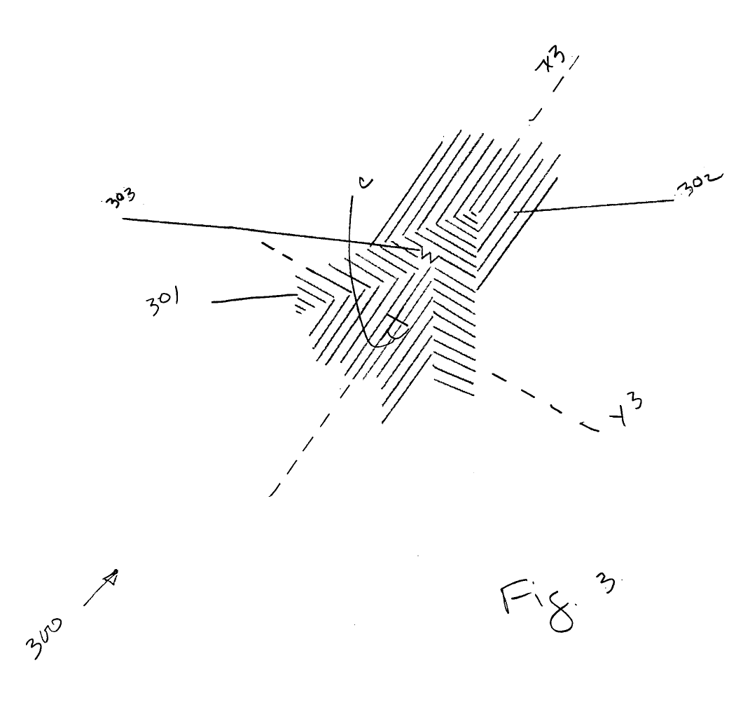

In a typical scenario, a person wishing to send covert information 101 over the internet may use form 100 on a computer that has fillable field 105. Covert information 101 may be entered into fillable field 105 either by the person completing the form 100 and/or the receiver of the form 100, who may want at least some of the details being sent to remain confidential. Either during or following the entry of the covert information 101 into fillable field 105, covert information 101 is embedded in background area 102 of document 100 as described below and shown in FIGS. 2 and 3. The form 100 may then be transmitted through electronic means, e.g., through the internet or by facsimile. In one embodiment of the invention, form 100 may be sent to an intermediate or a terminal service where the visible information in fillable field 105 may be removed leaving only the information hidden in background 102 for viewing by dedicated viewing device 110.

Dedicated viewing device 110 may be a lens made of either plastic, glass or film having a print element frequency that matches the print element frequency of covert information 101. Dedicated viewing device 110 may be clear, tinted or lined to assist the viewing of the covert information 101 and may contain several distinct areas for viewing of multiple screened areas.

For operation, dedicated viewing device 110 is simply held against covert information 110 for viewing. Use of the dedicated viewing device 110 may make the appearance of the image of background 102 paler or less noticeable while revealing covert information 101, as shown in FIG. 1.

Dedicated viewing device 110 may be designed to be easily destroyed after use to ensure extra document security.

In an alternative embodiment of the invention, the visible information disappears from the form 100 during or after embedding covert information into background area 102, thus rendering the electronic document free of information intended to be covert. With fillable field 105 rendered blank, an unintended viewer would not have access to the covert information 101. An intended user may then use dedicated viewer 110 to view covert information that has been embedded in background area 102. Most preferably, covert information 101 and background 102 may be created by using a software program such as Forms X6 for Quark Xpress by DigiComp, Maple Grove, Minn.

Reference is now made to FIG. 2, which is a simplified illustration of one embodiment of the present invention 200 having solid lines 201 and 202 at substantially different angles to each other to mask covert information 201. A user wanting to conceal covert information 201 from general view, may place covert information print elements, in this case, solid lines, 201, and background print elements, in this case, solid lines, 202, at substantially different angles to each other. Print elements of covert information 201 define axis x2 and print elements of background 202 define axis y2. Angle b between axes x1 and y1 preferably measures 90°, plus or minus 5°, as shown in FIG. 2, but can, in actuality, vary greatly. Of course, covert information print elements 201 and background print elements 202 could be replaced with dots, spots, swirls, or images (not shown), either individually or in combination.

FIG. 3 is a simplified illustration of one embodiment of the present invention 300 similar to FIGS. 1 and 2, having solid lines as print elements of the covert information and background, 301 and 302, respectively. Axes x3 and y3, defined by print elements 301 and 302, are disposed at angle c, again preferably 90°, plus or minus 5°, to mask the covert information. Additionally, print code 303 is inserted, preferably, at the vertex of angle C. Print codes can be used for additional security, authorship identification, or the like. Print code 303 is shown as the lower case letter “w” in FIG. 3, but can be comprised of any print element, including, but not limited to, lines, dots, spots, swirls, or images.

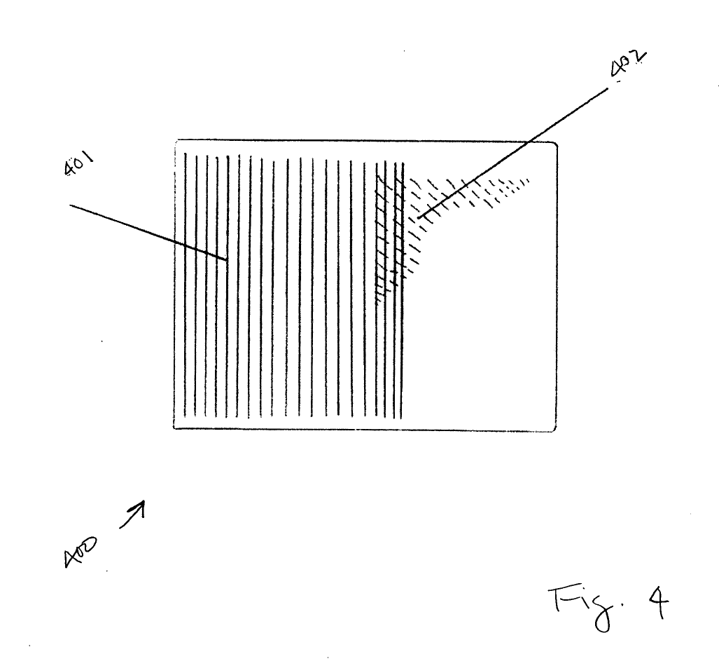

FIG. 4 is a simplified illustration of another embodiment of the present invention 400 in which covert information 402 cannot be easily scanned or copied. Covert information print elements 402, shown as broken lines, are used in combination with solid background 401, shown as solid lines in FIG. 4. By selecting the proper tints, print elements 401 can be hidden within solid background 401 and later viewed using a dedicated viewing device (not shown). Darker tints are preferred for solid background 401 and colored tints are preferred for covert information print elements 402.

A user wanting to isolate covert information 402 as shown in FIG. 4 may cover or underlay the covert information print elements 402 with a tint, color, paper substrate coloring or foil. Information displayed in this manner is seen as a solid tint. Covert information 402 may be most effectively concealed through the use of dark colors, metallic colors and/or UV inks. The user may choose to use a solid printed or tinted background or colored paper in addition to the dark or metallic or UV/IR ink. For example, the user may choose to print with blue ink on red paper, or red on a metallic blue solid area.

The metallic base tint may be overprinted with an opposite color that would further hide the covert information. UV and IR links used to create the information may be placed to reveal half of an image when a plastic or glass viewer is placed on top of the document and the balance of the image “appears when UV or IR light is shown through the viewing device onto the document. In such a way, additional “codes” may be hidden as secondary messages.

In all of the above embodiments, the user, having chosen to reveal covert information 101 to a recipient of the document, provides the recipient with a dedicated viewing device, shown as 110 in FIG. 1. If multiple areas of the document are used to hide multiple portions of covert information 101 and different recipients are intended to view different areas of covert information 101, the user provides each recipient of the document with a different viewing device 110, each designed to match the different covert information. The process can be accomplished by utilizing a different screen frequencies or different screen print elements, such as dots as covert information print elements for the first recipient and lines as covert information print elements for the second recipient. Alternatively, a page of a document containing a tint background may be transmitted and separately covert information printed to a translucent overlay may be transmitted such that when the overlay is placed over the background screen the covert information may be read.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below, finds experimental support in the following examples.

It is appreciated that certain features of the invention, which are for clarity, described in the context of separate embodiments, may also be provided in combination in a single embodiment. Conversely, various features of the invention, which are for brevity, described in the context of a single embodiment, may also be provided separately or in any suitable sub-combination, such as a document with specific covert information revealed partially by a laminate viewing device permanently affixed to the document that also contains additional covert information at a first, second or third print element frequency and or ink make-up.

Although the invention has been described in conjunction with specific embodiments thereof, it is evident that many alternatives, modifications and variations that fall within the spirit and broad scope of the appended claims. All publications, patents and patent application mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention

What is claimed is:

1. A method for providing an covert document system comprising:
creating a first print structure comprising a background;
creating a second print structure comprising covert information;
masking said covert information by combining said first print structure and said second print structure wherein said covert information is rendered substantially invisible to the naked eye and wherein said covert information is rendered visible using a dedicated viewing device.

2. The covert document system according to claim 1 wherein said background and said covert information are capable of being transmitted, copied, or otherwise successfully reproduced using an output device wherein said covert information is rendered substantially invisible to the naked eye and wherein said covert information is rendered visible using a dedicated viewing device.

3. The method according to claim 1 wherein said first print structure comprises a first plurality of print elements having a first axis and wherein said second print structure comprises a second plurality of print elements having a second axis, said first axis being disposed at an angle to said second axis.

4. The method according to claim 3 wherein said first and second plurality of print elements comprise dots, spots, lines, swirls, or images, either individually or in combination.

5. The method according to claim 4 wherein said first plurality of print elements and said second plurality of print elements are of substantially equal size.

6. The method according to claim 4 wherein said first plurality of print elements and said second plurality of print elements are of substantially equal density.

7. The method according to claim 1 wherein said dedicated viewing device comprises a substantially transparent, tinted, or lined substrate.

8. The method according to claim 1 wherein said dedicated viewing device comprises a scanner.

9. The method according to claim 1 wherein said viewing device is capable of easily being destroyed after use.

10. The method according to claim 1 wherein masking said covert information is accomplished by using hardware, software, or firmware, either individually or in combination.

11. The method according to claim 1 further comprising inserting a print code into said second print structure.

12. The method according to claim 1 wherein said background comprises a solid tint.

13. The method according to claim 12 wherein creating said covert information comprises selecting a covert information outline and filling in said covert information outline with a plurality of print elements.

14. The method according to claim 13 wherein said print elements comprise a plurality of dots, spots, lines, swirls, or images, either individually or in combination.

15. The method according to claim 1 wherein said covert information is incapable of being viewed after being copied, transmitted, or otherwise reproduced by an output device.

16. The method according to claim 1 wherein said background and said covert information comprise opposite color tints.

17. A covert document system comprising:
a document having a background thereon;
a quantity of covert information disposed within said background wherein said covert information is rendered substantially invisible to the naked eye;
a viewing device dedicated to said covert information.

18. The covert document system according to claim 17 wherein said quantity of covert information is capable of being transmitted, copied, or otherwise successfully reproduced using an output device with said quantity of covert information being viewable with the use of said viewing device.

19. The covert document system according to claim 17 wherein said background comprises a first plurality of print elements generally defining a first axis and wherein said quantity of covert information comprises a second plurality of print elements generally defining a second axis, said first axis disposed at an angle to said second axis.

20. The covert document system according to claim 19 wherein said first and second plurality of print elements comprise dots, spots, lines, swirls, or images, either individually or in combination.

21. The covert document system according to claim 20 wherein said first plurality of print elements and said second plurality of print elements are of substantially equal size.

22. The covert document system according to claim 20 wherein said first plurality of print elements and said second plurality of print elements are of substantially equal density.

23. The covert document system according to claim 17 wherein said covert information comprises predetermined lines, dots, spots, swirls, or images over a foil image.

24. The covert document system according to claim 17 wherein said viewing device comprises a substantially transparent, tinted, or lined substrate.

25. The covert document system according to claim 17 wherein said viewing device comprises a scanner.

26. The covert document system according to claim 17 wherein said viewing device is capable of being easily destroyed after use.

27. The covert document system according to claim 17 wherein said viewing device comprises a plurality of distinct viewing areas having different frequencies or using different print elements.

28. The covert document system according to claim 17 wherein said covert information is created using hardware, software, or firmware, either individually or in combination.

29. The covert document system according to claim 17 wherein said background comprises a solid tint and said covert information comprises a plurality of print elements.

30. The covert document system according to claim 29 wherein said covert information comprises a covert information outline filled in with said plurality of print elements.

31. The covert document system according to claim 30 wherein said print elements comprise a plurality of dots, spots, lines, swirls, or images, either individually or in combination.

32. The covert document system according to claim 31 wherein said covert document is incapable of being copied, transmitted, or otherwise successfully reproduced by an output device.

33. The covert document system according to claim 32 wherein said output device comprises a color scanner or color printer.

34. The covert document system according to claim 17 wherein said background and said quantity of covert information comprise opposite color tints.

35. The covert document system according to claim 17 wherein said viewing device is capable of easily being destroyed after use.

36. The covert document according to claim 17 further comprising a print code disposed within said second print structure.

37. A method of providing a covert document system comprising:
providing a document;
creating a background disposed on said document;
creating a quantity of covert information within said background wherein said quantity of covert information is substantially invisible to the naked eye;
wherein a viewing device that matches said quantity of covert information allows said quantity of covert information to be viewed.

38. The method according to claim 37 wherein said background and said quantity of covert information are capable of being transmitted, copied, or otherwise successfully reproduced by an output device without revealing said quantity of covert information until viewed by said viewing device.

39. The method according to claim 38 further comprising transmitting said background and said quantity of covert information from a first user to a second user, said second user disposing said quantity of covert information into said background.

40. The method according to claim 39 further comprising transmitting said background and said quantity of covert information to a third user, said third user viewing said covert information using said viewing device.

41. The method according to claim 39 further comprising:
creating a second quantity of covert information disposed within said background;
transmitting said background and said second quantity of covert information to a second user;
providing a second viewing device that matches said second quantity of covert information wherein said second user views said second quantity of covert information using said second viewing device.

42. The method according to claim 38 further comprising:
creating a second quantity of covert information disposed within a second background;
transmitting said second background and said second quantity of covert information to a second user;
providing a second viewing device that matches said second quantity of covert information wherein said second user views said second quantity of covert information using said second viewing device.

43. The method according to claim 37 wherein said viewing device is transmitted by said output device.
